(19) United States
(12) Patent Application Publication
(10) Pub. No.: US 2001/0035033 A1
(43) Pub. Date: Nov. 1, 2001

(54) Closing device

(75) Inventor: Torsten Wegner, Wiesbaden (DE)

Correspondence Address: Martin A. Farber, Suite 473, 866 United Nations Plaza, New York, NY, 10017, US

(73) Assignee: Mannesmann VDO AG

(21) Appl. No.: 09/797,367

(22) Filed: Feb. 28, 2001

Related U.S. Application Data
(63) Continuation of application No. 09/433,692, filed on Nov. 3, 1999, now abandoned.
Application No. 09/433,692 is a division of application No. 08/995,066, filed on Dec. 19, 1997, now Pat. No. 6,082,158.

(30) Foreign Application Priority Data
Dec. 21, 1996 (DE) 196 53 760.6
Dec. 12, 1997 (DE) 197 55 207.2

(51) Int. Cl. B60R 25/00

(52) U.S. Cl. 70/237

(57) ABSTRACT

The invention relates to a lock device, in particular for doors of motor vehicles, having lock elements such as at least rotary latch and pawl, in which at least one lock element (pawl 1) can be connected via connecting elements with at least one handle or such connection can be eliminated, characterized by the fact that an actuator device has a cam disk (6) the connection being made or eliminated as a function of the cam disk (6).

The present invention relates to a closing device in accordance with the preamble to the independent claims.

Such a closing device is known from DE 196 35 415.3 (Filing date: Aug. 31, 1996).

In the case of said closing device, it has happened that when a handle is operated, the coupling member between the handles jams and the operating device may thus be damaged. In the worst case it may even happen that the actuator fails completely, as a result of which the actuator no longer operates. This is of particular disadvantage from safety standpoint.

The object of the present invention therefore is to improve a closing device in such a way that its operation is assured in every operating situation and that jamming of the parts of the closing device is avoided.

This object is achieved by the features contained in the independent claims.

The use of a cam disk or of a contoured disk has the advantage that it acts on elements of the closing device in such a manner that at least one element of the lock can be connected to at least one handle, or such connection can be eliminated. Assurance is thus had that the element is present either in the force-transmission path between handle and lock element and actuation of the handle is transmitted to an element of the lock (pawl) in order to open a door of the vehicle. In the second position of the element, the element is moved out of the force-transmission path between the lock element and the handle by the contoured or cam disk, so that actuation of the handle has no result. The jamming of this element between further lock elements is thus no longer possible. At the same time, all functions of the closing device, such as, for instance, anti-theft security, central lock, unlocking position and child-safety position can be realized with one or more cam or contoured disks.

As a further development of the invention, the actuator is an electric motor which bears the cam disk or the contoured disk on its setting shaft. This is an advantage since in this way a rotatory construction of the parts is possible, in which a high freedom in design is possible, and with which the function and movement of the cam or contoured disk can be realized in a particularly simple manner.

As a further development of the invention, the cam disk or contoured disk can be driven stepped-down by the actuator. This has the advantage that relatively small electric motors can be used as actuators, which then apply the required torque as a result of the step-down ratio so as to turn the cam disk or contoured disk. This is of advantage, in particular in the case of a cam disk, since it, it is true, can move the element in one direction, while movement in the opposite direction is possible only with the expending of force on the element (for instance, spring force). In order to overcome this action of force in the one direction, the disk must be capable of being driven stepped-down. As an alternative to this, it is possible, with a suitably dimensioned actuating device, also to provide a stepped-up transmission as a result of which there is obtained the advantage that a particularly rapid displacement of the element from the one position into the other position and vice versa is possible.

Further embodiments of the invention are indicated in the subordinate claims, these embodiments being described below and explained on basis of the figures.

In the drawing:

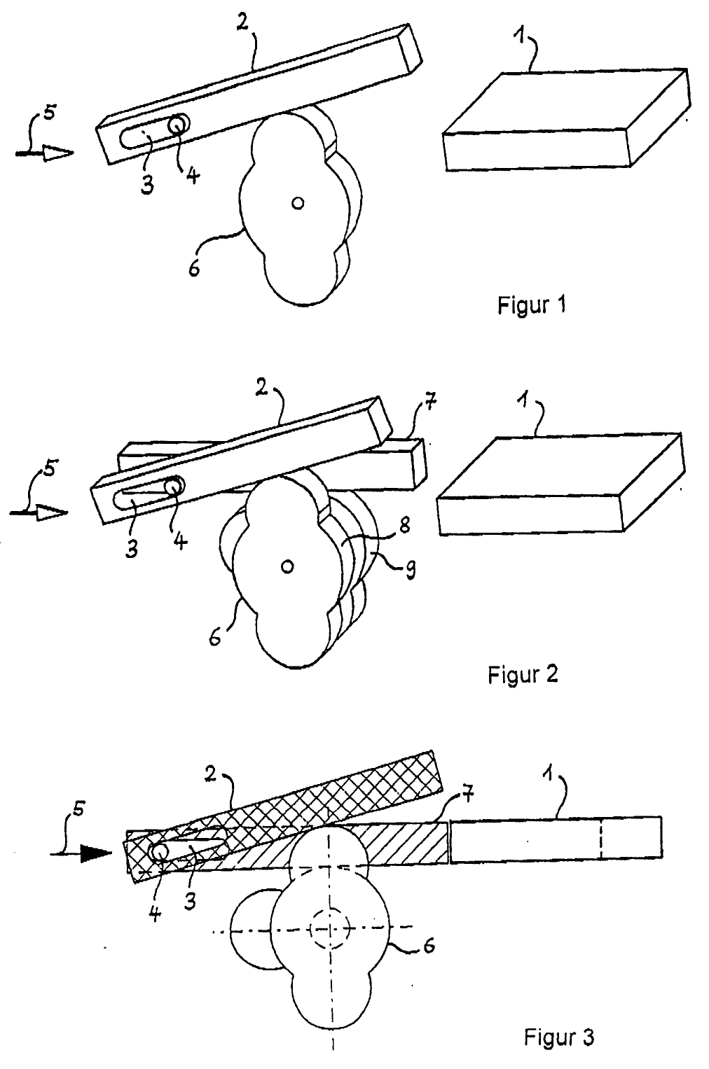

FIG. 1 shows a closing device for the actuation by a handle;

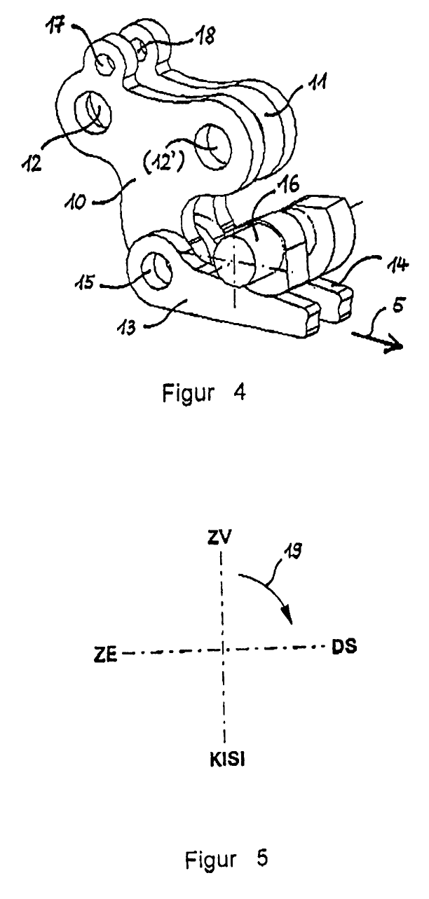

FIG. 2 shows a closing device for actuation by two handles;

FIG. 3 shows a position of an actuated closing device;

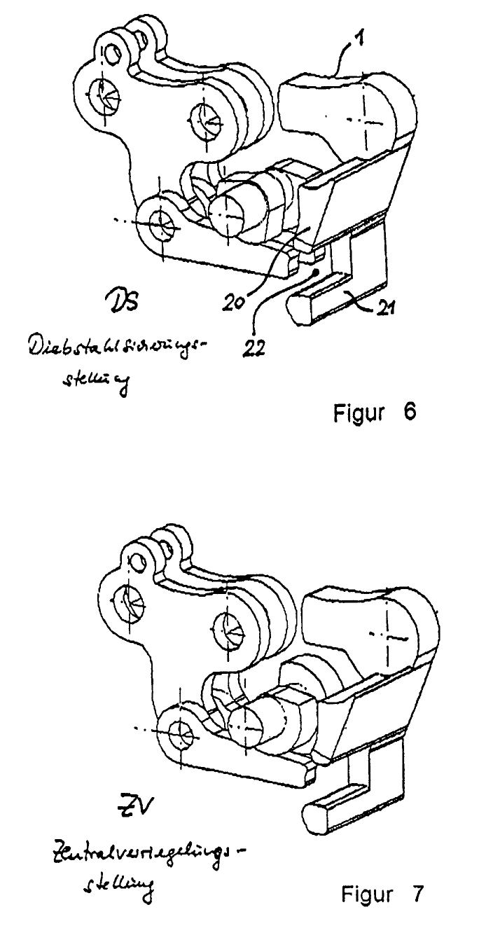

FIG. 4 shows a structural development of a closing device;

FIG. 5 shows possible positions of the actuator;

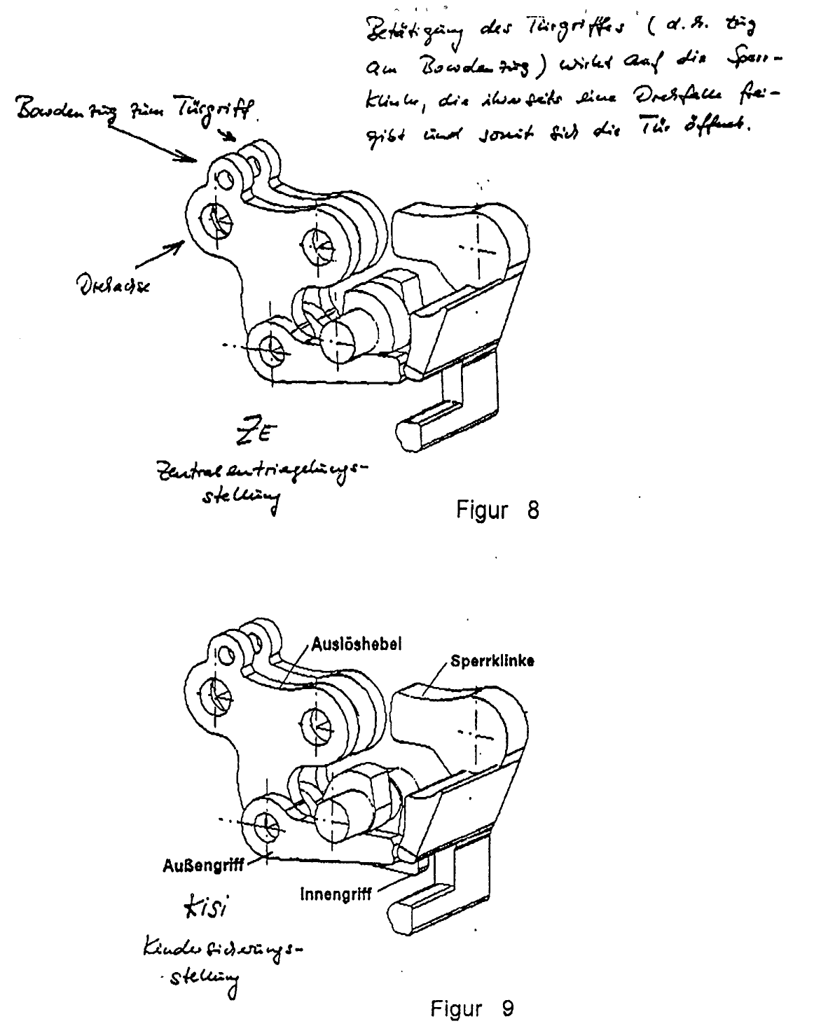

FIGS. 6 to 11 show positions of the closing device in accordance with FIG. 5;

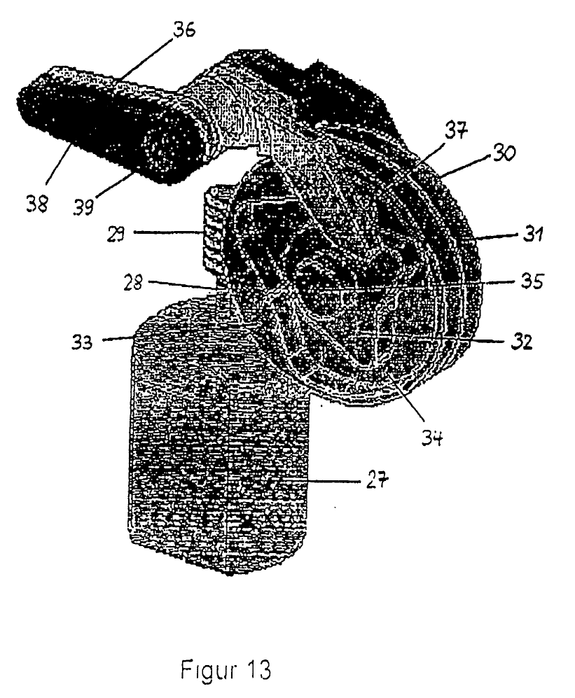

FIG. 12 shows another structural development of the closing device; and

FIG. 13 shows a closing device having a contoured disk.

FIG. 1 shows a diagrammatically depicted closing device such as used, for instance, on car doors, trunks or the like. The manner of operation of the closing device is based thereon that the door is provided with at least one handle (for instance, inside door handle or door outside handle), in which connection the operation of this one handle is transmitted via connecting elements (for instance, Bowden cables, rods, or the like) to a lock element. Such a lock handle may, for instance, be a pawl which, in known manner, locks or releases a rotary trap in its closed position. The rotary trap, which is developed in U-shape, surrounds by its two arms a closure bolt in order to hold the door in its closed position. After release of the rotary trap by actuation of the pawl, the closure bolt can slider out of the region of the arms of the rotary latch so that the door can be opened. The actuating of the handle can be noted, for instance, by microswitches, the output signal of which effects the control of the actuator.

Such a pawl is shown diagrammatically in FIG. 1, and provided with the reference numeral 1. In order to actuate the pawl 1, a slider 2 (or lever or the like) is provided which has a slot 3 on one end, the slider 2 being turnable around an axis of rotation in the region of the slot 3. Upon actuation of the handle in the direction of actuation 5, the slider 2 is actuated in the direction toward the pawl 1 in order to release the rotary trap by means of the pawl. Movement of the slider 2 opposite the direction of actuation 5 is effected for instance by means of spring force.

In accordance with the invention, a cam disk 6 is now provided the outer contour of which acts on the slider 2 in such a manner that upon actuation of the slider 2 by means of the handle, said slider 2 can be brought into operative connection with the pawl 1 in order to open the door or to bring the slider 2 into such a position (lifted in accordance with FIG. 1) so that this connection cannot be produced or can be eliminated. In such a case, movement of the slider 2 in the direction of actuation 5 achieves nothing, so that the door remains closed. The cam disk 6 can be arranged on a shaft of an electric motor or the like and be turnable around the latter. As an alternative to this, drive by means of step-up or step-down transmission is possible, in which case, the drive of the can disk can also be effected via a friction wheels on the outer contour, this friction wheel being acted on by force in order to follow along the outer contours of the can disk 6.

FIG. 2 shows an embodiment similar to FIG. 1, but in this case the cam disk 6 has two planes which differ at least in part from each other, so that the slider 2 (which is associated, for instance, with the door inside handle), and another slider 7 (which is associated, for instance, with the door outside handle) are actuated by the cam disk, which has a first plane for the actuating of the slider 2 and a second plane 9, which differs from the first plane 8 and is associated with the slider 7. The manner of operation is the same as in FIG. 1, in which embodiment, however, the pawl 1 is now in this embodiment to be actuated either by the door inside handle and/or by the door outside handle. There could also be possible two cam disks 6—approximately in the arrangement shown in FIG. 1—which can be driven independently of each other by a separate actuating device.

FIG. 3 shows an embodiment in accordance with FIG. 2, in which actuation of the pawl 1 is effected by actuation of a handle in the direction of actuation 5. The contour of the second plane 9 of the cam disk 8, which contour is associated with the further slider 7 makes it possible for this slider 7 to actuate the pawl 1, while the actuating of the handle which acts on the slider 2 effects nothing. This is the case, for instance, when access to the central locking position from the outside is not to be possible but, on the other hand, the opening of the door from the inside must be possible.

FIG. 4 shows a structural development of the closing device in which a first actuating lever 10 and a second actuating lever 11 are movable around a common pivot pin 12. Actuation of a handle acts on a actuating lever in such a manner that the two actuating levers 10 and 11 are movable independently of each other. On one end of the corresponding actuating lever 10, 11, a first lever 13 is arranged around a pivot pin 15 and a second lever 14 around a pivot pin 15, so that an actuating of the handle on one or both actuating levers effects a movement of both levers 13, 14 in the direction of actuation 5. Whether such a movement is to act now on the pawl or not is determined by the fact that the cam disk has two planes which are at least partially different from each other in the form of a cam shaft 16, the cam contour of which acts in each case on a lever 13, 14 (or slider 2, 7). The cam shaft 16, which can be driven by the actuating device (electric motor), then brings it about that, upon the actuation of a handle, both levers 13, 14 can be brought into operating connection with the pawl 1 or not, or that only one of the two levers can be brought into operative connection and the other not, or vice versa.

In FIG. 4, it is shown that the actuating levers 10, 11 are movable around a common pivot pin 12 when connecting elements, such as, for instance, Bowden cables, rods or the like, for a lever are attached to a second point of attack 18. Upon the introduction of force on the point of attack 17 or 18, when viewing FIG. 4 from the left, a movement of the levers 13, 14 takes place in the direction of actuation 5 (substantially to the right); as an alternative to this, a common pivot pin 12′ is provided so that the introduction of force on the points of attack 17, 18 is possible when viewing FIG. 4 also towards the bottom in order to effect a movement of the levers 13, 14 in the direction of actuation 5.

FIG. 5 shows the positions of the cam disk 6 and the cam shaft 16 respectively. Starting from a first position (for instance central lock position ZV for one or more doors), a rotation of the cam disk 6 and of the cam shaft 16 respectively takes place in the direction of rotation 19, in which case, after about ¼ of a revolution, an anti-theft position DS (in particular for all doors/trunk) takes place, after a further ¼ revolution the child-safety position KISI (in particular for the rear doors) is reached and after a further ¼ revolution the central unlock position ZE (for one or more doors) is reached. A direction of rotation 19 in only clockwise or counterclockwise direction is possible, in which case also combination thereof is conceivable (reversal of direction of rotation).

In FIGS. 6 to 11, the positions are shown which can be assumed in accordance with FIG. 5, in which case an association of the numerals with the abbreviations in FIG. 5 is effected and described.

The structural development which is shown in FIGS. 6 to 11 is based essentially on the embodiment already described in connection with FIG. 4. Supplementing the embodiment described in FIG. 4, there is also shown the pawl 1 which has a first extension 20 and a second extension 21, a window 22 being present between them. The significance and manner of operation of the these parts will be described in the following.

FIG. 6 shows the anti-theft position DS. This means that the position of the cam shaft 16 sees to it that, upon the actuation of one or both handles, both the first and the second handles 13, 14 enter into the region of the window 22, so that the pawl 1 is not moved, and thus the door cannot be opened from either the inside or the outside.

FIG. 7 shows the central locking position ZV in which, after rotation of the cam shaft 16, the cam shaft so adjusts the two levers 13, 14 that actuation of the door outside handle (first lever 13) does not permit actuation of the pawl 1, but actuation of the door inside handle 5 (second lever 14) permits actuation of the pawl 1; the door can be opened from the inside but not from the outside.

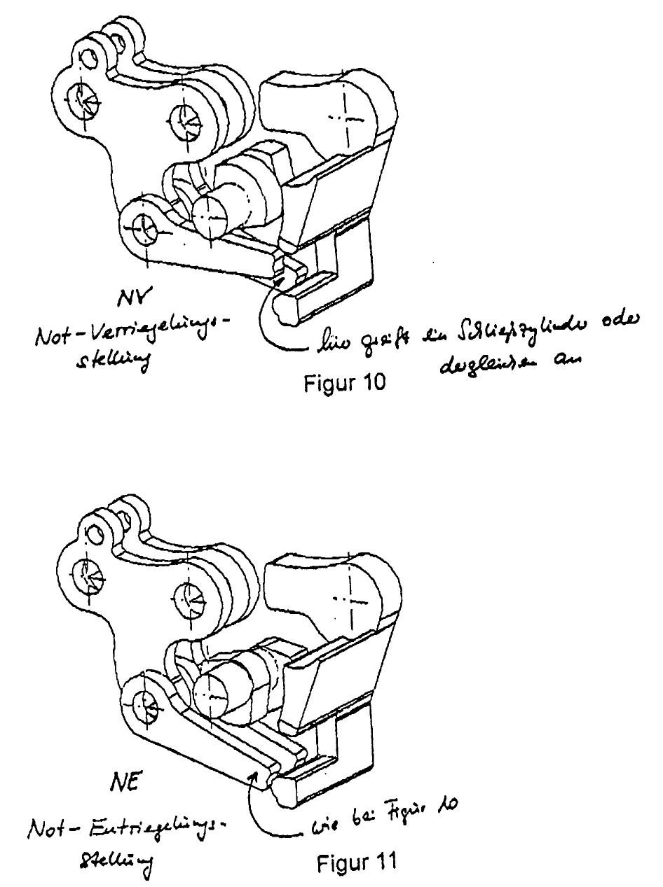

FIG. 8 shows the central unlocked position ZE in which the cam shaft 16 permits such a position of the two levers 13, 14 in which, upon actuation of the door outside handle and of the door inside handle, the pawl 1 can be actuated; the door can be opened both from the inside and from the outside.

FIG. 9 shows the child-safety position KISI which makes it possible, on basis of the position of the cam shaft 16, for the door to be opened via the actuation of the door outside handle, but the door remaining closed upon actuation of the door inside handle.

Should, against all expectations, the actuator fail (for instance, failure of current which renders the electric motor inactive), it is provided, in accordance with the invention, that, for this, the pawl 1 has the further extension 21 on which the first lever 13 and/or the second lever 14 can come to rest after actuation of a actuating device (such as, for example, a closure cylinder).

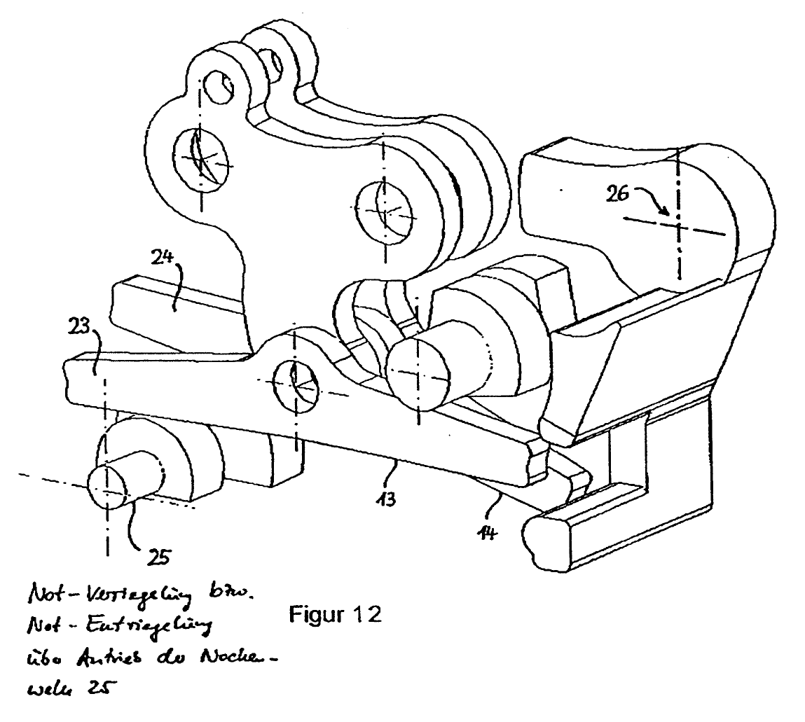

FIG. 10 shows the so-called emergency lock, in which the cam shaft 16 has remained in such a position which would actually make it possible for the first lever 13 to come to rest against with the first extension 20 of the pawl 1 in order to actuate it. Since this is not desired, the first lever 13 is brought by an actuating device into such a position that one end of the lever 13 points in the direction of the window 22, so that, for instance by means of a key, the closing device can be brought into the emergency lock position so that access to the vehicle is not possible.

The same applies for an emergency unlock in the case of which the cam shaft 16 has remained in a position which actually does not permit actuation of the pawl 1. Thus, after swingings of at least the first lever, it is possible that upon actuation of the door inside handle or door outside handle, the first lever comes to rest with the second extension 21 and actuates the pawl 1.

FIG. 12 shows a further development of the closing device in which, by way of supplementation of the embodiment shown in FIG. 4, both the first lever 13 and the second lever 14 have extensions 23, 24 beyond the axis of rotation 15. In the region of these extensions 23, 24 there is a further cam shaft 25, in which connection, after rotation of the cam shaft 25, the emergency lock and emergency unlock shown in FIGS. 10 and 11 can be carried out. Either the cam shaft 25 is movable via a closure cylinder or, as an alternative to this, it is also possible to provide an electric setting device with its own current supply in order to turn the cam shaft 25. In this connection, however, assurance must be had that not every unauthorized person can connect such a setting device to an additional voltage supply since access to the motor vehicle would, in principle, then be possible by means of the “emergency unlock” position.

In order to show the structural development of the pawl 1, FIG. 12 also shows a pivot pin 28 of the pawl 1, such as also present in the preceding figures.

FIG. 13 shows a closing device having a contoured disk, the embodiment shown in FIG. 13 and described below taking the place of the cam shaft 16 or cam disk in accordance with the preceding figures.

FIG. 13 shows an electrically actuatable lock having an actuator which is developed as electric motor. A worm gear 29 is seated on a shaft 28 of the electric motor 27, a transmission element developed as contoured disk 30 being driven by the electric motor 27. An outer circumference 31 of the contoured disk 30 is provided with teeth (not shown in FIG. 13) which mesh with the worm gear 29 and thus form a stepped-down gearing. At least one side of the contoured disk 30 has inner elevations 32 and outer elevations 33 which form an intermediate region 34. The inner and outer elevations 32, 33 form a contour for the establishing of different functions of the lock, as will be described later on. The contoured disk 30 is mounted for rotation on a shaft 35. The reference numeral 36 designates a first lever the end of which associated with the contoured disk 30 bearing a pin 37 which extends into the intermediate region 34 and can rest on the contours of the inner elevations 32 and outer elevations 33. There is also shown in FIG. 13 a second lever 38 which is mounted with the first lever 36 on a common shaft 38 and, independently of the first lever 36, can be set by means of inner elevations and outer elevations on the other side of the contoured disk 30. It may be mentioned here that, with the embodiment shown in FIG. 13, the actuation of the door inside handle and of the door outside handle may or may not be transmitted directly, or via the interspersion of further transmission elements, to lock elements such as, for instance, pawl/rotary latch. It is also possible to associate with an individual handle (such as, for instance, door inside handle) a separate electric motor with its own contoured disk and inner elevations and outer elevations on only one side and also only a single lever. Since the development of the lock elements does not affect the development of the actuator, a showing was dispensed with here. To make this clear, reference is had to FIG. 4, so that a lever 36, 38 acts in each case instead of the cam shaft 16 on a lever 13, 14. The development in accordance with FIG. 13 is advantageously arranged as a module in a dust-proof and splash-water protected housing with an electric plug for supplying the electric motor 27 with voltage and for reporting back the position (for instance of the contoured disk 30), the levers 36, 38 extending out of the housing in order to act on further elements.

This embodiment which is shown in FIG. 13 therefore permits an extremely flat construction which permits all functions of an electrically actuatable lock, such as unlocking, locking, and anti-theft protection (possibly also child-safety). By a corresponding control of the electric motor 27 and the movement of the levers 36 and 38 as a function of the contours of the contoured disk 30, the lock functions for two handles (such as door inside handle and door outside handle) are realized with only one actuator (electric motor 27).

### List of Reference Numerals

1. Pawl

2. Slider

3. Slot

4. Axis of rotation (pivot pin)

5. Direction of actuation

6. Cam disk

7. Further sliders

8. First plane

9. Second plane

10. First actuating lever

11. Second actuating lever

12. Common axis of rotation (pivot pin)

13. First lever

14. Second lever

15. First axis of rotation (pivot pin)

16. Cam shaft

17. First point of attack

18. Second point of attack

19. Direction of rotation

20. First extension

21. Second extension

22. Window

23. Lengthening

24. Lengthening

25. Cam shaft

26. Axis of rotation (pivot pin)

27. Electric motor

28. Shaft

29. Worm gear

30. Contoured disk

31. Outer circumference

32. Inner elevations

33. Outer elevations

34. Intermediate region

35. Shaft

36. First lever

37. Pin

38. Second lever

39. Shaft

1. A closing device, in particular for doors of motor vehicles, having lock elements such as at least rotary latch and pawl, wherein, via connecting elements, at least one lock element (pawl 1) can be connected with at least one handle or said connection can be eliminated, characterized by the fact that an actuator has a cam disk (6), the connection being made or eliminated as a function of the cam disk (6).

2. A closing device, in particular for doors of motor vehicles, having lock elements, such as at least rotary latch and pawl, wherein at least one lock element (pawl 1) can be connected via connecting elements with at least one handle or said connection can be eliminated, characterized by the fact that an actuator has a contoured disk (30), the connection being made or eliminated as a function of the position of the contoured disk (30).

3. A closing device according to claim 1, characterized by the fact that the actuator is an electric motor which bears the cam disk (6) on its actuator shaft.

4. A closing device according to claim 1, characterized by the fact that the cam disk (6) can be driven stepped-down by the actuator.

5. A closing device according to claim 1, characterized by the fact that the cam disk (6) actuates at least one lever, slider, or the like, it coming into contact or not with the lock element as a function of the position of the cam disk (6).

6. A closing device according to claim 1, characterized by the fact that the cam disk (6) has two at least partially different planes in the form of a cam shaft (16) which differ at least partially from each other, their cam contours acting in each case on a lever (13, 14), slider or the like.

7. A closing device according to claim 1, characterized by the fact that at least one handle is connected, possibly via connecting elements, with at least one actuating lever (10, 11), the lever (13, 14) being rotatably mounted on the actuating lever (10, 11).

8. A closing device according to claim 1, characterized by the fact that the pawl (1) has at least one extension (20) against which at least one of the two levers (13, 14) can come to rest.

9. A closing device according to claim 1, characterized by the fact that the pawl (1) has a further extension (21) on which the lever or levers (13, 14) can come to rest by actuation of an actuating device (such as, for instance, of a closure cylinder).

10. A closing device according to claim 3, characterized by the fact that the cam disk (6) has at least one lever, slider or the like, which comes to rest or not against the closure element as a function of the position of the cam disk (6).

11. A closing device according to claim 6, characterized by the fact that at least one handle is connected, possibly via connecting elements, with at least one actuating lever (10, 11), the lever (13, 14) being turnably mounted on the actuating lever (10, 11).

12. A closing device according to claim 1, characterized by the fact that the pawl (1) has at least one extension (20) against which both levers (13, 14) can come to rest.

13. A closing device according to claim 8, characterized by the fact that the pawl (1) has a further extension (21) against which the lever or levers (13, 14) can come to rest by actuation of an actuating device (such as, for instance, a closure cylinder).

14. A closing device according to claim 2, characterized by the fact that the actuating device is an electric motor which bears the contoured disk (30) on its actuator shaft.

15. A closing device according to claim 2, characterized by the fact that the contoured disk (30) can be driven stepped-down from the actuator device.

16. A closing device according to claim 14, characterized by the fact that the contoured disk (30) actuates at least one lever, slider, or the like, in which connection the latter comes to rest or not as a function of the position or the contoured disk (30) with the lock element or a further element which comes against the lock element.

17. A closing device according to claim 15, characterized by the fact that the contoured disk (30) actuates at least one lever, slider or the like, which comes to rest or not as a function of the position of the contoured disk (30), against the lock element or a further element, which acts on the lock element.
